(19) United States
(12) Patent Application Publication
(10) Pub. No.: US 2019/0278266 A1
(43) Pub. Date: Sep. 12, 2019

(54) VEHICLE CONTROLLING APPARATUS AND VEHICLE

(71) Applicant: HONDA MOTOR CO., LTD., Tokyo (JP)

(72) Inventors: Hisashi MATSUDA, Wako-shi (JP); Kentaro ISHISAKA, Wako-shi (JP); Takashi WATANABE, Wako-shi (JP); Takafumi HIROSE, Wako-shi (JP); Takemi TSUKADA, Wako-shi (JP); Katsuya YASHIRO, Wako-shi (JP); Toru KOKAKI, Wako-shi (JP); Masaya IKEDA, Wako-shi (JP)

(21) Appl. No.: 16/281,831

(22) Filed: Feb. 21, 2019

(30) Foreign Application Priority Data
Mar. 7, 2018 (JP) 2018-040966

(51) Int. Cl. G05D 1/00; B60W 50/14

(52) U.S. Cl. CPC G05D 1/0061; G05D 1/0088; B60W 2050/146; G05D 2201/0213; B60W 50/14

(57) ABSTRACT

A control apparatus for controlling a vehicle includes a travel control unit configured to perform travel control of the vehicle and a guidance unit capable of providing guidance relating to the travel control. When an operation of the travel control unit is controlled by an operation apparatus, the guidance unit determines whether to provide guidance on a basis of a past operation state of at least one of the travel control unit or the guidance unit.

### CROSS-REFERENCE TO RELATED APPLICATION(S)

This application claims priority to and the benefit of Japanese Patent Application No. 2018-040966 filed on Mar. 7, 2018, the entire disclosure of which is incorporated herein by reference.

### BACKGROUND OF THE INVENTION

### Field of the Invention

The present invention relates to a vehicle controlling apparatus and a vehicle.

### Description of the Related Art

Techniques for automatically driving a vehicle such as a four-wheel vehicle (so-called automated driving techniques) have been increasingly developed. Guidance (a tutorial) is provided to the driver at the start of automated driving. Japanese Patent Laid-Open No. 2017-151703 discloses that a tutorial is started only when the safety is sufficiently assured. Japanese Patent Laid-Open No. 2017-151704 discloses that a plurality of tutorials can be used in switching from automated driving control to a manual operation.

### SUMMARY OF THE INVENTION

When the same guidance is repetitively provided, the driver might be discomforted. An aspect of the present invention provides a technique for appropriately providing guidance to the driver. According to an embodiment of the present invention, a control apparatus for controlling a vehicle, the control apparatus comprising: a travel control unit configured to perform travel control of the vehicle; and a guidance unit capable of providing guidance relating to the travel control, wherein when an operation of the travel control unit is controlled by an operation apparatus, the guidance unit determines whether to provide guidance on a basis of a past operation state of at least one of the travel control unit or the guidance unit is provided.

### BRIEF DESCRIPTION OF THE DRAWINGS

FIG. 1 is a block diagram illustrating an exemplary configuration of a vehicle according to an embodiment.

FIG. 2 is a flowchart of an exemplary operation of a vehicle controlling apparatus according to the embodiment.

FIG. 3 is a diagram illustrating an exemplary display of a screen according to the embodiment.

FIG. 4 is a diagram illustrating an exemplary display of a screen according to the embodiment.

### DESCRIPTION OF THE EMBODIMENTS

Embodiments of the present invention are described below with reference to the accompanying drawings. In the embodiments, identical components are denoted with the same reference symbols, and repetitive descriptions are omitted. In addition, the embodiments may be modified and combined.

A vehicle 1 includes a vehicle controlling apparatus 2 (hereinafter referred to simply as “control apparatus 2”) that controls the vehicle 1. The control apparatus 2 includes a plurality of ECUs 20 to 29 that are connected with each other via an in-vehicle network such that they can communicate with each other. Each ECU includes a processor typified by a CPU, a memory such as a semiconductor memory, an interface for an external device and the like. The memory stores programs executed by the processor, data used by the processor for processes and the like. Each ECU may include a plurality of processors, memories, interfaces and the like. For example, the ECU 20 includes a processor 20a and a memory 20b. When an order included in a program stored in the memory 20b is executed by the processor 20a, a process is executed by the ECU 20. Alternatively, the ECU 20 may include a dedicated integrated circuit such as an ASIC for executing a process of the ECU 20. The same applies to other ECUs.

The functions and the like of the ECUs 20 to 29 are described below. Note that the number and the functions of the ECUs may be appropriately designed, and may be further subdivided or combined in comparison with the present embodiment.

The ECU 20 executes a control relating to automated driving of the vehicle 1. In the automated driving, the steering and/or acceleration/deceleration of the vehicle 1 is automatically controlled. In the exemplary control described later, both the steering and the acceleration/deceleration are automatically controlled.

The ECU 21 controls an electric power steering apparatus 3. The electric power steering apparatus 3 includes a mechanism that steers the front wheel in accordance with a driving operation of a steering wheel 31 (steering operation) performed by the driver. The electric power steering apparatus 3 also includes a motor that generates a driving force for assisting the steering operation and automatically steering the front wheel, a sensor that detects the steering angle, and the like. When the vehicle 1 is in an automated driving state, the ECU 21 automatically controls the electric power steering apparatus 3 in response to an instruction from the ECU 20, and controls the travel direction of the vehicle 1.

The ECUs 22 and 23 control detection units 41 to 43 that detect the surrounding environment of the vehicle, and the ECUs 22 and 23 perform information processing on a detection result. The detection unit 41 is a camera (hereinafter referred to also as camera 41) that captures an image of the front side of the vehicle 1, and, in the present embodiment, the detection unit 41 is attached on the vehicle interior side of the windshield in a front portion of a roof of the vehicle 1. By analyzing the image captured by the camera 41, the outline of the target and a divisional line (such as a white line) of a lane on the road can be extracted.

The detection unit 42 is a light detection and ranging (LIDAR) (hereinafter referred to also as LIDAR 42). The detection unit 42 detects a target around the vehicle 1 and measures the distance from a target. In the present embodiment, five LIDARs 42 are provided at the front and rear corners of the vehicle 1 and at a center of the rear part of the vehicle 1. The detection unit 43 is a millimeter-wave radar (hereinafter referred to also as radar 43). The detection unit 43 detects a target around the vehicle 1 and measures the distance from a target. In the present embodiment, five radars 43 are provided at a center of the front part of the vehicle 1 and at the front and rear corners of the vehicle 1.

The ECU 22 controls one camera 41 and each LIDAR 42 and performs information processing on a detection result. The ECU 23 controls the other camera 42 and each radar 43 and performs information processing on a detection result. The reliability of the detection result can be improved with two pairs of apparatuses for detecting the surrounding environment of the vehicle, and a many-sided analysis of the surrounding environment of the vehicle can be performed with the detection units of different types including the cameras, the LIDARs, and the radars.

An ECU 24 controls a gyro sensor 5, a GPS sensor 24b and a communication apparatus 24c and performs information processing on a detection result or a communication result. The gyro sensor 5 detects a rotational movement of the vehicle 1. The advancing direction of the vehicle 1 can be determined based on a detection result of the gyro sensor 5, the wheel speed and the like. The GPS sensor 24b detects the present position of the vehicle 1. The communication apparatus 24c performs radio communication with a server for providing map information and traffic information to acquire the map information and the traffic information. The ECU 24 can access a database 24a of map information created in the memory, and the ECU 24 performs a route search from the present position to the destination, and the like. The ECU 24, the map database 24a and the GPS sensor 24b constitute a so-called navigation apparatus.

An ECU 25 includes a communication apparatus 25a for inter-vehicle communications. The communication apparatus 25a performs radio communication with other vehicles in the surrounding region to exchange information between the vehicles.

An ECU 26 controls a power plant 6. The power plant 6 is a mechanism that outputs a driving force for rotating the driving wheel of the vehicle 1, and includes an engine and a transmission, for example. The ECU 26 controls the engine output in accordance with a driving operation of the driver (an accelerator operation or an acceleration operation) detected by an operation detection sensor 7a provided in an accelerator pedal 7A, and switches the gear ratio of the transmission on the basis of information such as the vehicle speed detected by a vehicle speed sensor 7c, for example. When the vehicle 1 is in an automated driving state, the ECU 26 automatically controls the power plant 6 in response to an instruction from the ECU 20, and controls the acceleration and the deceleration of the vehicle 1.

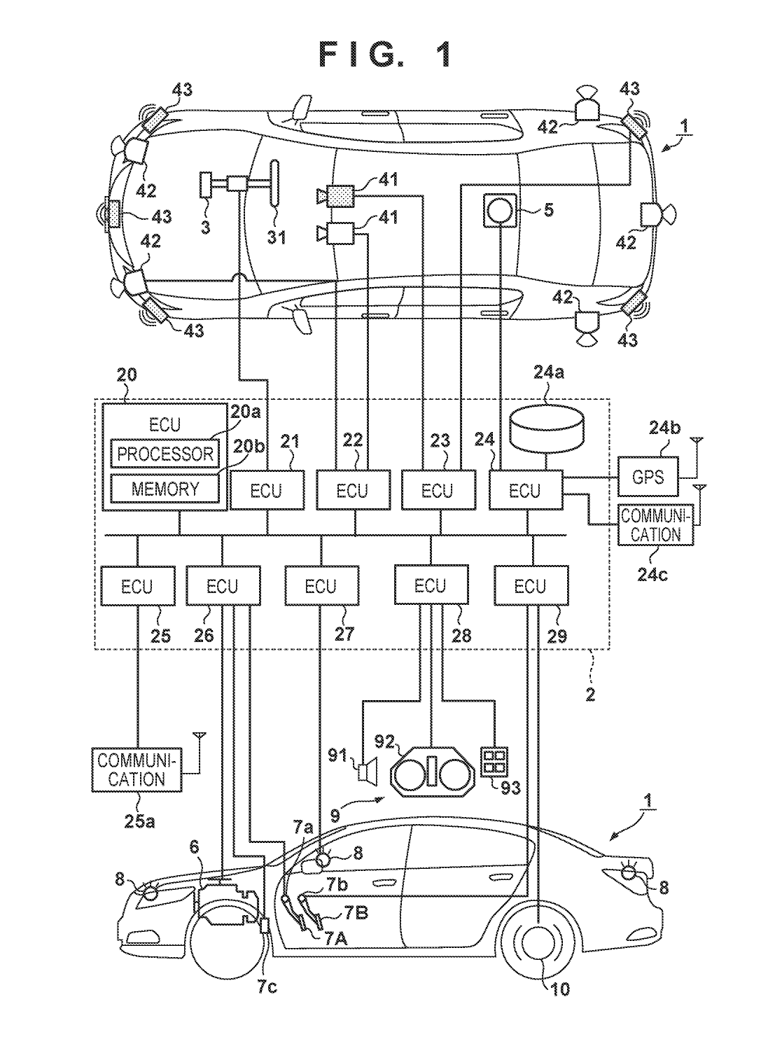

The ECU 27 controls lighting devices (such as a headlight and a tail light) including directional indicators 8 (blinkers). In the example illustrated in FIG. 1, the directional indicators 8 are provided at the front part, the door mirror and the rear part of the vehicle 1.

The ECU 28 controls an input/output apparatus 9. The input/output apparatus 9 outputs information to the driver and receives information from the driver. A sound output apparatus 91 notifies the driver of information by means of sound. A display device 92 notifies the driver of information by displaying an image. The display device 92 is disposed in front of the driver's seat and constitutes an instrument panel and the like. While sound and image display are exemplified here, vibration and/or light may be used for notification of information. Alternatively, any combination of sound, display, vibration and light may be used for notification. Further, the combination and/or the notification mode may be changed in accordance with the level (e.g. the degree of urgency) of the information to be notified. An input apparatus 93, which is a switch group disposed at a position where it can be operated by the driver and configured to give an instruction to the vehicle 1, may include a sound input apparatus. The ECU 28 can provide guidance relating to the travel control of the ECU 20. Details of the guidance is described later. The input apparatus 93 may include a switch used for controlling the operation of the travel control of the ECU 20.

The ECU 29 controls a brake apparatus 10 and/or a parking brake (not illustrated in the drawing). The brake apparatus 10 is a disk brake apparatus, and is provided for each wheel of the vehicle 1, for example. The brake apparatus 10 exerts a resistance on the rotation of the wheel to decelerate or stop the vehicle 1. The ECU 29 controls the operation of the brake apparatus 10 in accordance with a driving operation (brake operation) of the driver detected by an operation detection sensor 7b provided in a brake pedal 7B, for example. When the vehicle 1 is in an automated driving state, the ECU 29 automatically controls the brake apparatus 10 in response to an instruction from the ECU 20, and controls deceleration and stoppage of the vehicle 1. The brake apparatus 10 and/or the parking brake may operate to maintain the stopping state of the vehicle 1. In addition, in the case that the transmission of the power plant 6 has a parking lock mechanism, the mechanism may operate to maintain the stopping state of the vehicle 1.

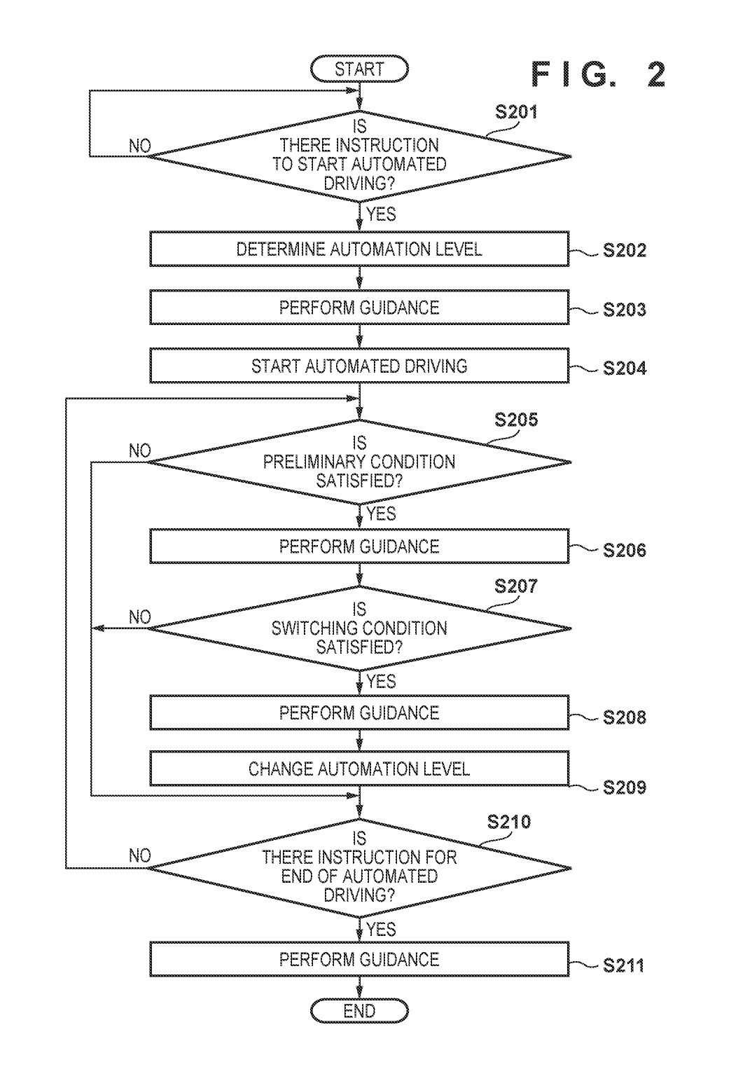

Now an exemplary operation of the control apparatus 2 is described with reference to FIG. 2. This operation is repetitively executed during driving of the vehicle 1 in parallel with other operations. For example, this operation may be executed during manual driving of the driver of the vehicle 1.

At step S201, the control apparatus 2 (e.g. the ECU 20) determines whether an instruction of starting automated driving is received from the driver. The instruction for the start may be provided with a start switch that is a part of the input apparatus 93, for example. When the instruction for the start is received (at step S201 “YES”), the control apparatus 2 advances the process to step S202. When the instruction for the start is not received (at step S201 “NO”), the control apparatus 2 returns the process to step S201.

At step S202, the control apparatus 2 (e.g. the ECU 20) determines the automation level of the automated driving in accordance with the current state of the vehicle 1. The automation level is a value representing the degree of the automation of the travel control, and is classified into level 1 to level 4 (the greater the numerical value, the greater the degree of automation), for example. Each level may be further subdivided into a plurality of levels. The driver task to be imposed on the driver differs depending on the automation level. For example, in the case that the automation level is level 2, the task of compulsorily monitoring the surroundings is imposed on the driver. In the case that the automation level is level 3, the task of compulsorily monitoring the surroundings is not imposed on the driver. In general, the higher the automation level, the lower the driver task. When the vehicle 1 is travelling on a highway and the vehicle speed is lower than 30 km per hour, the control apparatus 2 determines that the automation level is the level 3, and when the vehicle 1 is travelling on a highway and the vehicle speed is equal to or higher than 30 km per hour, the control apparatus 2 determines that the automation level is the level 2. In addition, when the vehicle 1 is travelling on a normal road, the control apparatus 2 determines that the automation level is the level 1.

At step S203, the control apparatus 2 (e.g. the ECU 28) provides guidance to the driver of the vehicle 1. Details of the provision of guidance is described later. At step S204, the control apparatus 2 (e.g. the ECU 20) starts travel control of the automated driving. Specifically, the control apparatus 2 performs travel control according to the determined automation level.

At step S205, the control apparatus 2 (e.g. the ECU 20) determines whether the state of the vehicle 1 satisfies a preliminary condition. When the preliminary condition is satisfied (at step S205 “YES”), the control apparatus 2 advances the process to S206, and when the preliminary condition is not satisfied (at step S205 “NO”), the control apparatus 2 advances the process to step S210. The preliminary condition is a condition for determining a harbinger for changing the automation level. For example, a case is assumed in which the condition for performing the automated driving of level 3 includes a vehicle speed lower than 30 km per hour, as described above. In this case, when the vehicle speed is 25 km per hour or higher, the preliminary condition is satisfied. At step S206, the control apparatus 2 (e.g. the ECU 20) provides guidance to the driver of the vehicle 1. Details of the provision of guidance is described later.

At step S207, the control apparatus 2 (e.g. the ECU 20) determines whether the state of the vehicle 1 satisfies the switching condition. When the switching condition is satisfied (at step S207 “YES”), the control apparatus 2 advances the process to step S208, and when the switching condition is not satisfied (at step S207 “NO”), the control apparatus 2 advances the process to step S209. The switching condition is a condition for changing the automation level. For example, a case is assumed in which the condition for performing the automated driving of level 3 includes a vehicle speed lower than 30 km per hour, as described above. In this case, when the speed of the vehicle 1 is 30 km per hour or higher, the switching condition is satisfied. The above-described preliminary condition is more relaxed than the switching condition. At step S208, the control apparatus 2 (e.g. the ECU 20) provides guidance to the driver of the vehicle 1. Details of the provision of guidance is described later. At step S209, the control apparatus 2 (e.g. the ECU 20) changes the automation level and continues the travel control of the automated driving.

At step S210, the control apparatus 2 (e.g. the ECU 20) determines whether an instruction of terminating the automated driving is received from the driver. The instruction of termination may be provided with a termination switch that is a part of the input apparatus 93, for example. When the instruction of termination is received (at step S210 “YES”), the control apparatus 2 terminates the process, and when the instruction of termination is not received (at step S219 “NO”), the control apparatus 2 returns the process to step S205.

Now details of the provision of guidance at the steps S203, S206, S208 and S211 are described. The control apparatus 2 (e.g. the ECU 28) can provide guidance (tutorial) relating to the travel control. The guidance relating to the travel control includes a notification of a start of the travel control, a request (task) to the driver, cautions in automated driving, and tips for automated driving, for example. The guidance differs depending on the surrounding environment of the vehicle 1 and the automation level to be provided. For example, in travel control of level 2, the driver is requested to monitor the surroundings. Then, the control apparatus 2 provides guidance “Automated driving of level 2 is started. Monitor surroundings.” as guidance regarding the request of monitoring of the surroundings, for example. In travel control of level 3, the driver is not requested to monitor the surroundings, but is requested to respond to a takeover request. Then, the control apparatus 2 provides guidance “Automated driving of level 3 is started. Takeover may be requested in case of emergency.” as guidance regarding the response request, for example.

To reduce discomfort of the driver due to repetition of the same guidance, the control apparatus 2 (e.g. the ECU 28) determines whether to provide guidance. Whether to provide guidance is determined based on the past operation state of at least one of the ECU 20 that performs the travel control and the ECU 28 that can provide the guidance, for example.

The past operation state may include the elapsed time or the travel distance after travel control or guidance is provided in the past. For example, in any of the following cases, the control apparatus 2 determines that the guidance is not provided.
A case that the elapsed time after the last travel control is equal to or shorter than a threshold time (e.g. three days); and
a case that the elapsed time after the last guidance is equal to or shorter than a threshold time (e.g. three days).

In addition to or in place of the above-mentioned conditions, the control apparatus 2 may determine that the guidance is not provided in any of the following cases.
A case that during the last guidance, the driver canceled it; and
a case that travel control of automated driving is performed threshold times (e.g. ten times) or more.

The determination based on the state of the guidance provided in the past may be performed for each type of the guidance. For example, guidance of “Monitor surroundings.” and guidance of “Push termination button when terminating automated driving.” are separately determined.

Whether to provide the guidance may be determined for each vehicle, or for each individual driver. For example, the past operation state is associated with each individual driver. Therefore, even in the case that a driver is riding in another vehicle, it is possible to reduce a situation that the guidance provided in the previous vehicle is provided more than necessary.

Whether to provide the guidance may be determined based on at least one of the estimated duration or the estimated continuous distance of the travel control and the degree of the automation that can be provided, for example. The estimated duration of the travel control is an estimation value relating to the time for which the travel control can be continued. When the estimated duration of the travel control is shorter than a threshold time (e.g. 20 seconds), the travel control might be terminated during provision of guidance in some situation. In this case, the control apparatus 2 determines that the guidance is not provided. The estimated continuous distance of the travel control is an estimation value relating to a distance in which the travel control can be continued. When the estimated continuous distance of the travel control is shorter than a threshold distance (e.g. 100 m), the travel control might be terminated during provision of guidance in some situation. In this case, the control apparatus 2 determines that the guidance is not provided. In addition, when the degree of the automation that can be provided is low (e.g., the case that the level is level 1), it is recognized that the driver is sufficiently accustomed to the travel control in that state, and accordingly the control apparatus 2 determines that the guidance is not provided. When the control apparatus 2 does not determine that the guidance is not provided, a notification is provided.

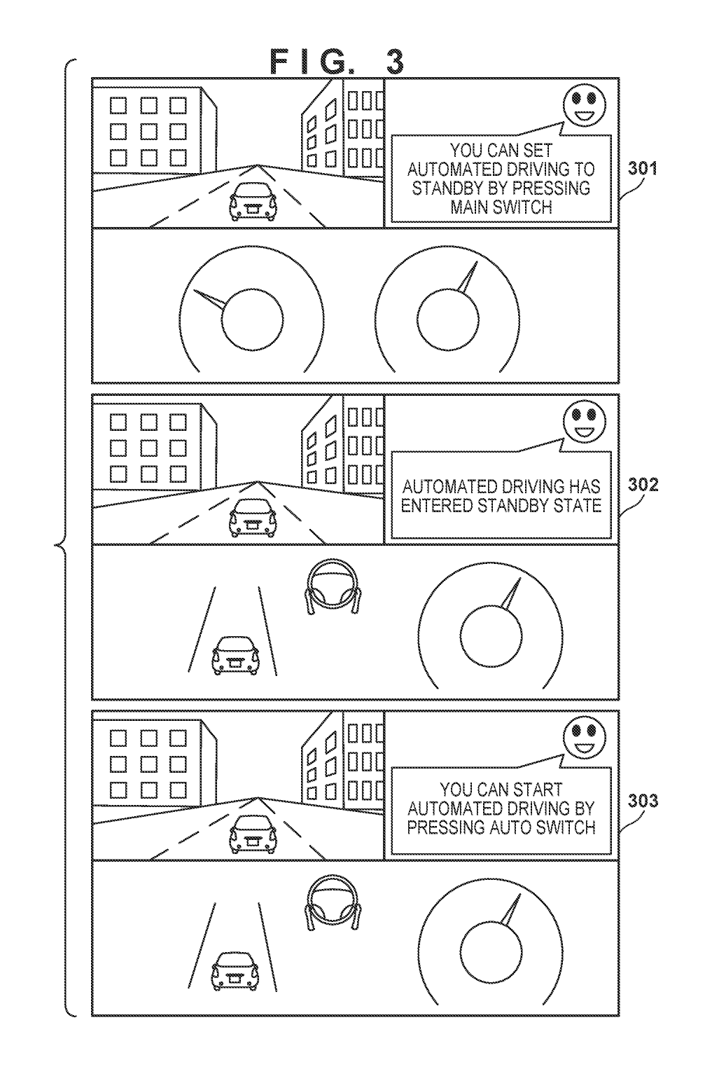

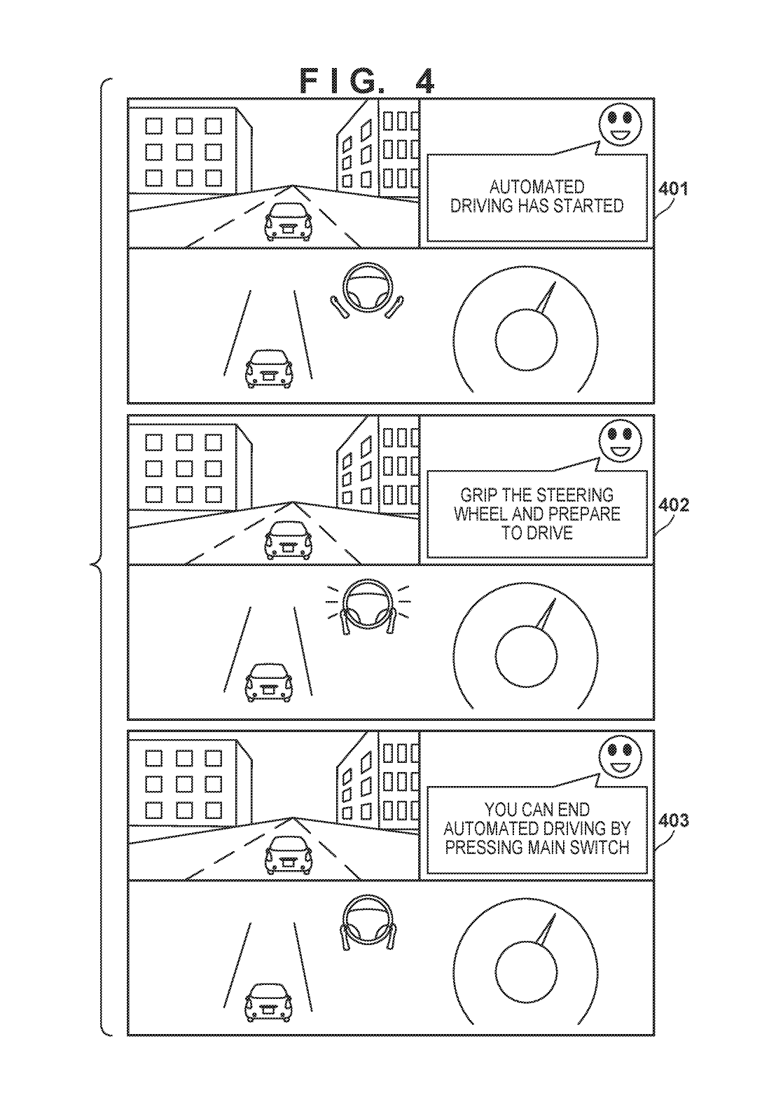

Now an exemplary display of guidance relating to the travel control is described with reference to FIGS. 3 and 4. Screens 301 to 303 and screens 401 to 403 are displayed on the display device 92. These screens may be displayed on other display devices instead of being displayed on the display device 92. For example, these screens may be displayed on a display device of a computer of a tablet and the like temporarily placed at a meter. The screen 301 is a screen that is displayed during manual driving. In an upper right portion of the screen 301, guidance (message) indicating that automated driving can be put into a standby state by pushing the main switch is displayed.

When the driver pushes the main switch, the screen 302 is displayed. In an upper right portion of the screen 302, guidance indicating that automated driving is in a standby state is displayed. Then, after a predetermined time (e.g. 15 seconds) has passed, the screen 303 is displayed. In an upper right portion of the screen 303, guidance (message) indicating that automated driving can be started by pushing the auto switch is displayed.

When the driver pushes the auto switch, the screen 401 is displayed. In an upper right portion of the screen 401, guidance (message) indicating that automated driving is started is displayed. Further, at a center portion of the screen 401, guidance (illustration) indicating that the driver is not required to grip the steering wheel is displayed. This guidance is closed after a predetermined time (e.g. 15 seconds) has passed.

When the state that the driver is not required to grip the steering wheel is changed to the state that the driver is required to grip the steering wheel, the screen 402 is displayed. In an upper right portion of the screen 402, guidance (message) indicating that the steering wheel is required to be gripped is displayed. Further, in a center portion of the screen 402, guidance (illustration) indicating that the driver is required to grip the steering wheel is displayed.

In an upper right portion of the screen 403, guidance (message) indicating that automated driving can be terminated by pushing the main switch is displayed.

### SUMMARY OF THE EXEMPLARY EMBODIMENT

### Configuration 1

A control apparatus (2) for controlling a vehicle (1), the control apparatus including:

a travel control unit (20) configured to perform travel control of the vehicle; and

a guidance unit (28) capable of providing guidance relating to the travel control.

When an operation of the travel control unit is controlled by an operation apparatus (92), the guidance unit determines whether to provide guidance on a basis of a past operation state of at least one of the travel control unit or the guidance unit.

With this configuration, unnecessary guidance can be reduced based on the past operation state.

### Configuration 2

The control apparatus according to Configuration 1, in which the past operation state includes an elapsed time or a travel distance after travel control or guidance is performed in a past.

With this configuration, unnecessary guidance can be further appropriately reduced.

### Configuration 3

The control apparatus according to Configuration 1 or 2, in which the past operation state is associated with an individual driver.

With this configuration, unnecessary guidance can be reduced even in the case that a driver is riding in another vehicle.

### Configuration 4

A control apparatus (2) for controlling a vehicle (1), the control apparatus including:

a travel control unit (20) configured to perform travel control of the vehicle; and

a guidance unit (28) capable of providing guidance relating to the travel control.

When an operation of the travel control unit is controlled by an operation apparatus (92), the guidance unit determines whether to provide guidance on a basis of at least one of an estimated duration or an estimated continuous distance of the travel control or a degree of automation that is allowed to be provided.

With this configuration, unnecessary guidance can be reduced based on an estimated state of the travel control.

### Configuration 5

A control apparatus (2) for controlling a vehicle (1), the control apparatus including:

a travel control unit (20) configured to perform travel control of the vehicle; and

a guidance unit (28) capable of providing guidance relating to the travel control.

The travel control includes

a first travel control, and

a second travel control that is lower in a driver task or higher in a degree of automation than the first travel control, and

the guidance unit is capable of providing a first guidance and a second guidance, the first guidance being configured for a first request to a driver in the first travel control, the second guidance being configured for a second request to the driver in the second travel control.

With this configuration, the guidance can be provided in accordance with the level of travel control, and therefore unnecessary guidance can be reduced.

### Configuration 6

The control apparatus according to Configuration 5, in which the guidance unit provides guidance when a preliminary condition is satisfied, the preliminary condition being more relaxed than a switching condition for switching from the second travel control to the first travel control.

With this configuration, the guidance can be provided before switching the travel control.

### Configuration 7

A vehicle (1) including the control apparatus according to any one of Configurations 1 to 6.

With this configuration, it is possible to provide a vehicle that can reduce unnecessary guidance.

What is claimed is:

1. A control apparatus for controlling a vehicle, the control apparatus comprising:
a travel control unit configured to perform travel control of the vehicle; and
a guidance unit capable of providing guidance relating to the travel control, wherein
when an operation of the travel control unit is controlled by an operation apparatus, the guidance unit determines whether to provide guidance on a basis of a past operation state of at least one of the travel control unit or the guidance unit.

2. The control apparatus according to claim 1, wherein the past operation state includes an elapsed time or a travel distance after travel control or guidance is performed in a past.

3. The control apparatus according to claim 1, wherein the past operation state is associated with an individual driver.

4. A control apparatus for controlling a vehicle, the control apparatus comprising:
a travel control unit configured to perform travel control of the vehicle; and
a guidance unit capable of providing guidance relating to the travel control, wherein
when an operation of the travel control unit is controlled by an operation apparatus, the guidance unit determines whether to provide guidance on a basis of at least one of an estimated duration or an estimated continuous distance of the travel control or a degree of automation that is allowed to be provided.

5. A control apparatus for controlling a vehicle, the control apparatus comprising:
a travel control unit configured to perform travel control of the vehicle; and
a guidance unit capable of providing guidance relating to the travel control, wherein
the travel control includes
a first travel control, and
a second travel control that is lower in a driver task or higher in a degree of automation than the first travel control, and
the guidance unit is capable of providing a first guidance and a second guidance, the first guidance being configured for a first request to a driver in the first travel control, the second guidance being configured for a second request to the driver in the second travel control.

6. The control apparatus according to claim 5, wherein the guidance unit provides guidance when a preliminary condition is satisfied, the preliminary condition being more relaxed than a switching condition for switching from the second travel control to the first travel control.

7. A vehicle comprising the control apparatus according to claim 1.

8. A vehicle comprising the control apparatus according to claim 4.

9. A vehicle comprising the control apparatus according to claim 5.
